(19) United States
(12) Patent Application Publication
(10) Pub. No.: US 2025/0378346 A1
(43) Pub. Date: Dec. 11, 2025

(54) SYSTEM AND METHOD FOR ONLINE, TASK-AWARE OPPONENT MODELING IN AUTONOMOUS RACING

(71) Applicant: TOYOTA RESEARCH INSTITUTE, INC., Los Altos, CA (US)

(72) Inventors: Paul TYLKIN, Philadelphia, PA (US); Letian CHEN, Atlanta, GA (US); Shawn Roshan MANUEL, Mountain View, CA (US); James Eugene DELGADO, San Carlos, CA (US); John Karl SUBOSITS, Mountain View, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/736,411

(22) Filed: Jun. 6, 2024

(51) Int. Cl. G06N 3/092; B60W 60/00

(52) U.S. Cl. CPC G06N 3/092; B60W 60/001; B60W 2300/28; B60W 2556/10

(57) ABSTRACT

A method for an online, task-aware opponent modeling in autonomous racing is described. The method includes concurrently training an opponent-aware policy and an opponent-aware encoder using reinforcement learning. The method also includes calculating, by the opponent-aware encoder, opponent encoding information according to prior opponent positions. The method further includes updating learning parameters of the opponent-aware policy using the opponent encoding information from the opponent-aware encoder to predict actions. The method also includes updating a posterior network according to an auxiliary mutual information loss between the actions predicted by the opponent-aware policy and the opponent encoding information from the opponent-aware encoder.

### BACKGROUND

### Field

Certain aspects of the present disclosure relate to autonomous vehicle technology and, more particularly, to a system and method for online, task-aware opponent modeling in autonomous racing.

### Background

Autonomous agents (e.g., vehicles, robots, etc.) rely on machine vision and sensors (IMU, GPS, etc.) for estimating the agent's state (velocity, position, etc.) for sensing a surrounding environment by analyzing areas of interest in a scene from images of the surrounding environment. Autonomous agents, such as driverless cars and robots, are quickly evolving and have become a reality in this decade. The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle, then the autonomous vehicle with a higher-level number offers a greater combination and quantity of autonomous features relative to the other vehicle.

Autonomous racing is a recently expanding subfield involving multi-agent settings by combining elements of robotics, control theory, and learning for developing performant agents in both simulation and using physical hardware. Successfully autonomous racing involves overcoming challenging multi-agent settings utilizing real-time continuous control that enables sophisticated driving with minimal error tolerance and strategic play to gain the best advantage over opponents. Despite prior work utilizing reinforcement learning in the context of autonomous racing, a significant aspect of autonomous racing, and automobile racing in general, is the strategic nature of interactions and the importance of informed opponent models. A task-aware opponent modeling in autonomous racing is desired.

### SUMMARY

A method for an online, task-aware opponent modeling in autonomous racing is described. The method includes concurrently training an opponent-aware policy and an opponent-aware encoder using reinforcement learning. The method also includes calculating, by the opponent-aware encoder, opponent encoding information according to prior opponent positions. The method further includes updating learning parameters of the opponent-aware policy using the opponent encoding information from the opponent-aware encoder to predict actions. The method also includes updating a posterior network according to an auxiliary mutual information loss between the actions predicted by the opponent-aware policy and the opponent encoding information from the opponent-aware encoder.

A non-transitory computer-readable medium having program code recorded thereon for an online, task-aware opponent modeling in autonomous racing is described. The program code is executed by a processor. The non-transitory computer-readable medium includes program code to concurrently train an opponent-aware policy and an opponent-aware encoder using reinforcement learning. The non-transitory computer-readable medium also includes program code to calculate, by the opponent-aware encoder, opponent encoding information according to prior opponent positions. The non-transitory computer-readable medium further includes program code to update learning parameters of the opponent-aware policy using the opponent encoding information from the opponent-aware encoder to predict actions. The non-transitory computer-readable medium also includes program code to update a posterior network according to an auxiliary mutual information loss between the actions predicted by the opponent-aware policy and the opponent encoding information from the opponent-aware encoder.

A system for an online, task-aware opponent modeling in autonomous racing is described. The system includes a concurrent model training module to concurrently train an opponent-aware policy and an opponent-aware encoder using reinforcement learning. The system also includes an opponent encoding model to calculate, by the opponent-aware encoder, opponent encoding information according to prior opponent positions. The system further includes an ego-vehicle policy model to update learning parameters of the opponent-aware policy using the opponent encoding information from the opponent-aware encoder to predict actions. The system also includes a mutual information loss module to update a posterior network according to an auxiliary mutual information loss between the actions predicted by the opponent-aware policy and the opponent encoding information from the opponent-aware encoder.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation using a system-on-a-chip (SOC) for a task-aware opponent modeling system, in accordance with aspects of the present disclosure.

FIG. 2 is a block diagram illustrating a software architecture that may modularize artificial intelligence (AI) functions for a task-aware opponent modeling system of an ego vehicle, according to aspects of the present disclosure.

FIG. 3 is a diagram illustrating an example of a hardware implementation for a task-aware opponent modeling system, according to aspects of the present disclosure.

FIGS. 4A-4B are block diagrams illustrating a vehicle configured with a task-aware opponent modeling system, according to aspects of the present disclosure.

FIG. 5 is a diagram illustrating an autonomous racing environment, according to various aspects of the present disclosure.

FIG. 6 is a block diagram illustrating a task-aware opponent modeling system, according to various aspects of the present disclosure.

FIG. 7 is a flowchart illustrating a method for task-aware opponent modeling, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. Any aspect of the present disclosure disclosed may be embodied by one or more elements of a claim.

Although aspects are described herein, many variations and permutations of these aspects fall within the scope of the present disclosure. Although some benefits and advantages of the preferred aspects are mentioned, the scope of the present disclosure is not intended to be limited to benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

The National Highway Traffic Safety Administration (“NHTSA”) has defined different “levels” of autonomous vehicles (e.g., Level 0, Level 1, Level 2, Level 3, Level 4, and Level 5). These various levels of autonomous vehicles may provide a safety system that improves driving of a vehicle. For example, in a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle. The set of ADAS features installed in the autonomous vehicle may be a lane centering assistance system, a lane departure warning system, and/or a brake assistance system and, in some configurations, intervene automatically in a guardian-mode as part of a shared control system.

Autonomous racing is a recently expanding subfield involving multi-agent settings by combining elements of robotics, control theory, and learning for developing performant agents in both simulation and using physical hardware. Successfully autonomous racing involves overcoming challenging multi-agent settings utilizing real-time continuous control that enables sophisticated driving with minimal error tolerance and strategic play to gain the best advantage over opponents. Deep reinforcement learning (RL) has also been successfully applied to multi-agent domains, in which multiple agents operate within a common environment to compete or to cooperate.

In multi-agent settings, RL agents learn not just how to perform a particular task, but also how to work with or compete against others. The current state-of-the-art multi-agent reinforcement learning (MARL) still lacks fast, accurate, and responsive modeling of other agents in the environment. This limits their ability to adapt to unseen adversaries or new partners, thereby restricting the applicability and robustness of learned models. In addition, humans use prior information about their adversaries to develop strategies and gain advantages over opponents during automobile racing. Despite prior work on using RL in this context, a significant aspect of autonomous racing, and automobile racing in general, is the strategic nature of interactions and the importance of informed opponent models. A task-aware opponent modeling in autonomous racing is desired.

Various aspects of the present disclosure are directed to an online, task-aware opponent modeling framework that combines reinforcement learning with self-supervised learning about one's opponents to find high-performance polices for autonomous racing of an ego vehicle. According to these aspects of the present disclosure, a task-aware opponent encoder is trained with reinforcement learning (e.g., the encoder outputs opponent information that is helpful for an ego-vehicle policy model to achieve a high reward). In various implementations, the system combines task-aware learning and mutual information maximization for training an opponent encoder. These aspects of the present disclosure identify the opponent information that is important for encoding and using by an ego-vehicle policy model and how the ego-vehicle policy model can learn the opponent encoding during a training process.

In operation, a task-aware opponent modeling system adds trajectories into a replay buffer for off-policy reinforcement learning and runs training for M iterations. In each iteration, the system samples a minibatch from the replay buffer and calculates the opponent encoding information according to prior opponent positions. Regarding loss calculations, learning parameters receive gradient updates from each loss function. Policy loss and mutual information loss update policy parameters and encoder parameters to generate actions having high performance. The system also factors opponent information and generates the opponent information from the encoder that is helpful for parameter adjustments. Furthermore, the mutual information loss updates a posterior network to supply correct learning signals for the mutual information loss.

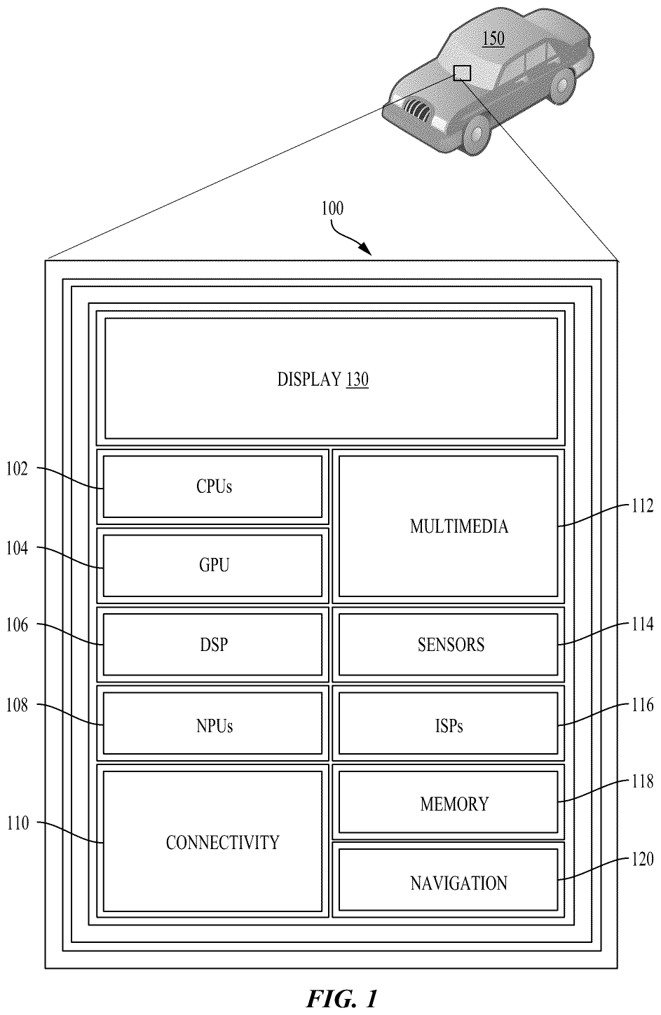

FIG. 1 illustrates an example implementation of the system and method for a task-aware opponent modeling system using a system-on-a-chip (SOC) 100 of a vehicle 150. The SOC 100 may include a single processor or multi-core processors (e.g., a central processing unit (CPU) 102), in accordance with certain aspects of the present disclosure. Variables, system parameters associated with a computational device, delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, unlicensed WiFi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on a reduced instruction set computing (RISC) machine, RISC-V, an advanced RISC machine (ARM), a microprocessor, or any reduced instruction set computing (RISC) architecture. In another aspect of the present disclosure, the SOC 100 may be a server computer in communication with the vehicle 150. In this arrangement, the vehicle 150 may include a processor and other features of the SOC 100. In this aspect of the present disclosure, instructions loaded into a processor (e.g., CPU 102) or the NPU 108 of the vehicle 150 may include program code to perform task-aware opponent modeling for autonomous vehicle racing improvement. For example, a task-aware opponent modeling system that combines reinforcement learning with self-supervised learning about one's opponents to find high-performance polices for autonomous racing of an ego vehicle.

The instructions loaded into a processor (e.g., CPU 102) may also include program code to concurrently train an ego-vehicle policy model and an opponent encoder model using reinforcement learning. The instructions loaded into a processor (e.g., CPU 102) may also include program code to calculate, by the opponent encoder model, opponent encoding information according to prior opponent positions. The instructions loaded into a processor (e.g., CPU 102) may also include program code to update learning parameters of the ego-vehicle policy model using the opponent encoding information from the opponent encoder model to predict actions. The instructions loaded into a processor (e.g., CPU 102) may also include program code to update a posterior network according to a mutual information loss between the actions predicted by the ego-vehicle policy model and the opponent encoding information from the opponent encoder model.

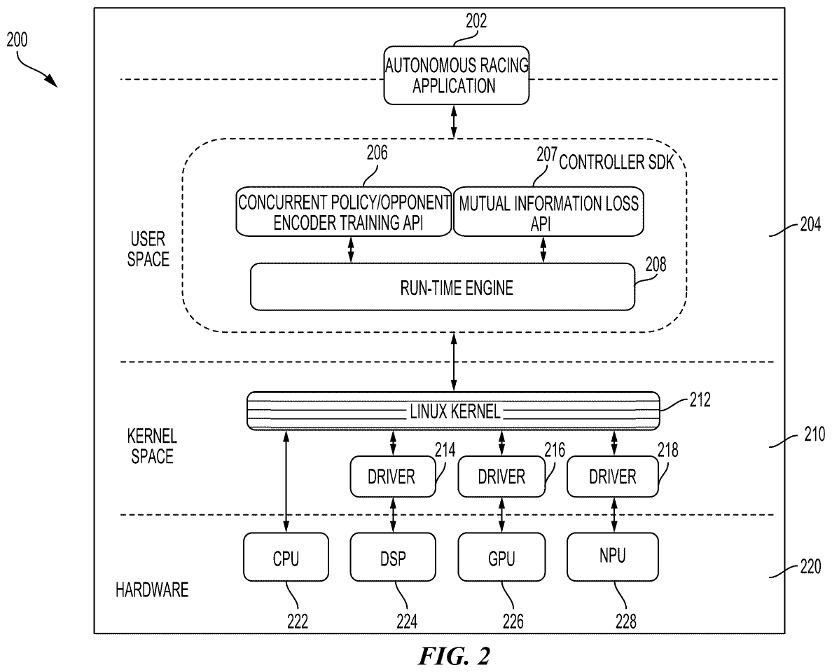

FIG. 2 is a block diagram illustrating a software architecture 200 that may modularize artificial intelligence (AI) functions for a task-aware opponent modeling system, according to aspects of the present disclosure. Using the software architecture 200, an autonomous racing application 202 may be designed such that it may cause various processing blocks of a system-on-a-chip (SOC) 220 (e.g., a CPU 222, a DSP 224, a GPU 226, and/or an NPU 228) to perform supporting computations during run-time operation of the autonomous racing application 202. While FIG. 2 describes the software architecture 200 for task-aware opponent modeling features, it should be recognized that the task-aware opponent modeling features are not limited to autonomous agents. According to aspects of the present disclosure, the task-aware opponent modeling system is applicable to any vehicle type, provided the vehicle is equipped with appropriate functions of an advanced driver assistance system (ADAS).

The autonomous racing application 202 may be configured to call functions defined in a user space 204 that may, for example, provide for task-aware opponent modeling services that combine reinforcement learning with self-supervised learning about one's opponents to find high-performance polices for autonomous racing of an ego vehicle. The autonomous racing application 202 may make a request to compile program code associated with a library defined in a concurrent policy/opponent encoder training application programming interface (API) 206 to concurrently train an ego-vehicle policy model and an opponent encoder model using reinforcement learning. The concurrent policy/opponent encoder training API 206 is further configured to update learning parameters of the ego-vehicle policy model using opponent encoding information from the opponent encoder model to predict actions. The autonomous racing application 202 may also make a request to compile program code associated with a library defined in a mutual information loss API 207 to update a posterior network according to a mutual information loss between the actions predicted by the ego-vehicle policy model and the opponent encoding information from the opponent encoder model. In response, the autonomous racing application 202 combines reinforcement learning with self-supervised learning about one's opponents to find high-performance polices for autonomous racing of an ego vehicle.

A run-time engine 208, which may be compiled code of a runtime framework, may be further accessible to the autonomous racing application 202. The autonomous racing application 202 may cause the run-time engine 208, for example, to take actions for communicating with a vehicle operator. When the vehicle operator begins to interact with a vehicle interface, the run-time engine 208 may in turn send a signal to an operating system 210, such as a Linux Kernel 212, running on the SOC 220. FIG. 2 illustrates the Linux Kernel 212 as software architecture for implementing the task-aware opponent modeling. It should be recognized, however, that aspects of the present disclosure are not limited to this exemplary software architecture. For example, other kernels may be used to provide the software architecture to support the autonomous racing functionality using the task-aware opponent model to find high-performance polices for autonomous racing of an ego vehicle.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, a nonlinear model predictive control (NMPC) may be configured to run on a combination of processing blocks, such as the CPU 222 and the GPU 226, or may be run on the NPU 228 if present. Alternatively, an opponent modeling framework could be used in conjunction with different control modalities and approaches, and NMPC is just one example.

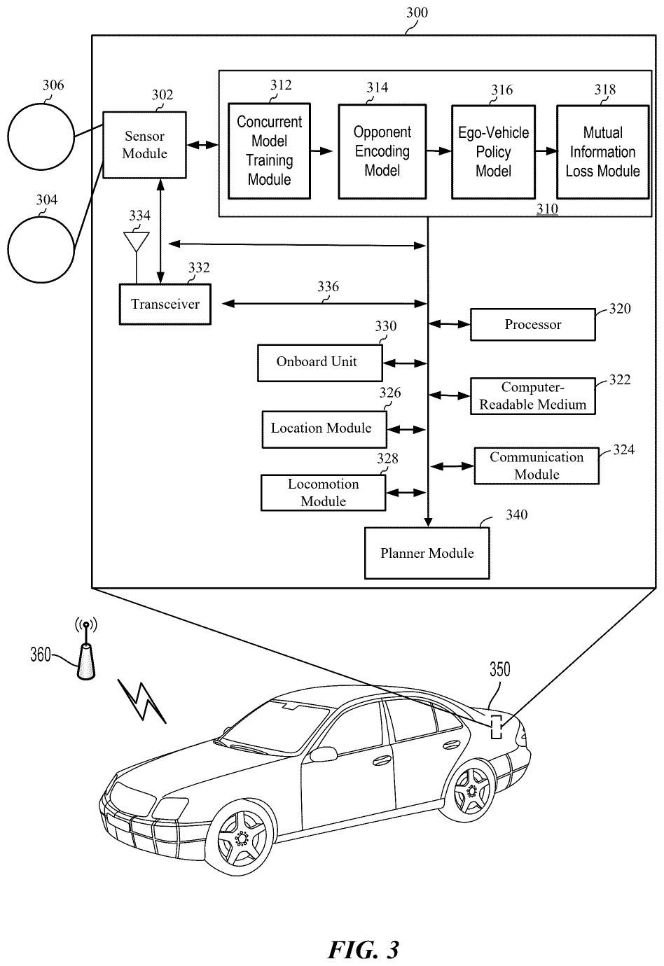

FIG. 3 is a diagram illustrating an example of a hardware implementation for a task-aware opponent modeling system 300, according to aspects of the present disclosure. The task-aware opponent modeling system 300 may be configured to support combined reinforcement learning with self-supervised learning about one's opponents to find high-performance polices for autonomous racing of a car 350. The task-aware opponent modeling system 300 may be a component of a vehicle or other non-autonomous device (e.g., non-autonomous vehicles). For example, as shown in FIG. 3, the task-aware opponent modeling system 300 is a component of the car 350.

Aspects of the present disclosure are not limited to the task-aware opponent modeling system 300 being a component of the car 350. Other devices, such as a bus, motorcycle, or other like non-autonomous vehicle, are also contemplated for implementing the task-aware opponent modeling system 300. In this example, the car 350 may be autonomous or semi-autonomous; however, other configurations for the car 350 are contemplated, such as an advanced driver assistance system (ADAS).

The task-aware opponent modeling system 300 may be implemented with an interconnected architecture, such as a controller area network (CAN) bus, represented by an interconnect 336. The interconnect 336 may include any number of point-to-point interconnects, buses, and/or bridges depending on the specific application of the task-aware opponent modeling system 300 and the overall design constraints. The interconnect 336 links together various circuits including one or more processors and/or hardware modules, represented by a sensor module 302, a vehicle controller 310, a processor 320, a computer-readable medium 322, a communication module 324, a location module 326, a locomotion module 328, an onboard unit 330, and a planner module 340. The interconnect 336 may also link various other circuits such as timing sources, peripherals, voltage regulators, and power management circuits, which are well known in the art, and therefore, will not be described further.

The task-aware opponent modeling system 300 includes a transceiver 332 coupled to the sensor module 302, the vehicle controller 310, the processor 320, the computer-readable medium 322, the communication module 324, the location module 326, the locomotion module 328, the onboard unit 330, and the planner module 340. The transceiver 332 is coupled to an antenna 334. The transceiver 332 communicates with various other devices over a transmission medium. For example, the transceiver 332 may receive commands via transmissions from a user or a connected vehicle. In this example, the transceiver 332 may receive/transmit vehicle-to-vehicle traffic state information for the vehicle controller 310 to/from connected vehicles within the vicinity of the car 350.

The task-aware opponent modeling system 300 includes the processor 320 coupled to the computer-readable medium 322. The processor 320 performs processing, including the execution of software stored on the computer-readable medium 322 to provide functionality according to the disclosure. The software, when executed by the processor 320, causes the task-aware opponent modeling system 300 to train a task-aware opponent encoder using reinforcement learning in which an encoder model outputs opponent information that is helpful for a policy of the car 350 to achieve a high reward. The task-aware opponent modeling system 300 is further caused to combine task-aware learning and mutual information maximization for training the opponent encoder model. The computer-readable medium 322 may also be used for storing data that is manipulated by the processor 320 when executing the software.

The sensor module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images of the vehicle operator. The second sensor 304 may be a ranging sensor, such as a light detection and ranging (LIDAR) sensor or a radio detection and ranging (RADAR) sensor for capturing an external vehicle environment. Of course, aspects of the present disclosure are not limited to the sensors, as other types of sensors (e.g., thermal, sonar, and/or lasers) are also contemplated for either of the first sensor 306 or the second sensor 304.

The measurements of the first sensor 306 and the second sensor 304 may be processed by the processor 320, the sensor module 302, the vehicle controller 310, the communication module 324, the location module 326, the locomotion module 328, the onboard unit 330, and/or the planner module 340. In conjunction with the computer-readable medium 322, the measurements of the first sensor 306 and the second sensor 304 are processed to implement the functionality described herein. In one configuration, the data captured by the first sensor 306 and the second sensor 304 may be transmitted to a connected vehicle via the transceiver 332. The first sensor 306 and the second sensor 304 may be coupled to the car 350 or may be in communication with the car 350.

The location module 326 may determine a location of the car 350. For example, the location module 326 may use a global positioning system (GPS) to determine the location of the car 350. The location module 326 may implement a dedicated short-range communication (DSRC)-compliant GPS unit. A DSRC-compliant GPS unit includes hardware and software to make the car 350 and/or the location module 326 compliant with one or more of the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 332. For example, the communication module 324 may be configured to provide communication capabilities via different wireless protocols, such as 6G, 5G NR, Wi-Fi, long term evolution (LTE), 4G, 3G, etc. The communication module 324 may also communicate with other components of the car 350 that are not modules of the task-aware opponent modeling system 300. The transceiver 332 may be a communications channel through a network access point 360. The communications channel may include DSRC, 6G, 5G NR, LTE, LTE-D2D, mm Wave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G NR, 6G, LTE, LTE-V2X, LTE-D2D, VOLTE, or any other mobile data network or combination of mobile data networks. Further, the network access point 360 may include one or more IEEE 802.11 wireless networks.

The task-aware opponent modeling system 300 also includes the planner module 340 for planning a route and controlling the locomotion of the car 350, via the locomotion module 328 for autonomous operation of the car 350. In one configuration, the planner module 340 may override a user input when the user input is expected (e.g., predicted) to cause a collision according to an autonomous level of the car 350. The modules may be software modules running in the processor 320, resident/stored in the computer-readable medium 322, and/or hardware modules coupled to the processor 320, or some combination thereof.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with the higher-level number offers a greater combination and quantity of autonomous features relative to the vehicle with the lower-level number. These distinct levels of autonomous vehicles are described briefly below.

Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is obliged to detect objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks but is still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the district where the vehicle is located).

A highly autonomous vehicle (“HAV”) is an autonomous vehicle that is Level 3 or higher. Accordingly, in some configurations the car 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The vehicle controller 310 may be in communication with the sensor module 302, the processor 320, the computer-readable medium 322, the communication module 324, the location module 326, the locomotion module 328, the onboard unit 330, the transceiver 332, and the planner module 340. In one configuration, the vehicle controller 310 receives sensor data from the sensor module 302. The sensor module 302 may receive the sensor data from the first sensor 306 and the second sensor 304. According to aspects of the present disclosure, the sensor module 302 may filter the data to remove noise, encode the data, decode the data, merge the data, extract frames, or perform other functions. In an alternate configuration, the vehicle controller 310 may receive sensor data directly from the first sensor 306 and the second sensor 304 to determine, for example, input traffic data images.

Autonomous racing is a recently expanding subfield involving multi-agent settings by combining elements of robotics, control theory, and learning for developing performant agents in both simulation and using physical hardware. Successfully autonomous racing involves overcoming challenging multi-agent settings utilizing real-time continuous control that enables sophisticated driving with minimal error tolerance and strategic play to gain the best advantage over opponents. Deep reinforcement learning (RL) has also been successfully applied to multi-agent domains, in which multiple agents operate within a common environment to compete or to cooperate.

In multi-agent settings, RL agents learn not just how to perform a particular task, but also how to work with or compete against others. The current state-of-the-art multi-agent reinforcement learning (MARL) still lacks fast, accurate, and responsive modeling of other agents in the environment. This limits their ability to adapt to unseen adversaries or new partners, thereby restricting the applicability and robustness of learned models. In addition, humans use prior information about their adversaries to develop strategies and gain advantages over opponents during automobile racing. Despite prior work on using RL in this context, a significant aspect of autonomous racing, and automobile racing in general, is the strategic nature of interactions and the importance of informed opponent models. A task-aware opponent modeling in autonomous racing is desired.

Various aspects of the present disclosure are directed to an online, task-aware opponent modeling framework that combines reinforcement learning with self-supervised learning about one's opponents to find high-performance polices for autonomous racing of an ego vehicle. According to these aspects of the present disclosure, a task-aware opponent encoder is trained with reinforcement learning (e.g., the encoder outputs opponent information that is helpful for an ego-vehicle policy model to achieve a high reward). In various implementations, the system combines task-aware learning and mutual information maximization for training an opponent encoder. These aspects of the present disclosure identify the opponent information that is important for encoding and using by an ego-vehicle policy model and how the ego-vehicle policy model can learn the opponent encoding during a training process.

As shown in FIG. 3, the task-aware opponent modeling system 300 includes the vehicle controller 310 that includes a concurrent model training module 312, an opponent encoding model 314, an ego-vehicle policy model 316, and a mutual information loss module 318. The concurrent model training module 312, the opponent encoding model 314, the ego-vehicle policy model 316, and the mutual information loss module 318 may be implemented using a convolutional neural network (CNN) using deep reinforcement learning (RL) and supervised learning (SL). The vehicle controller 310 is not limited to using a CNN trained using RL and/or SL.

The concurrent model training module 312 is configured to concurrently train an ego-vehicle policy model and an opponent encoder model using reinforcement learning. In response to the training, the opponent encoding model 314 is configured to calculate opponent encoding information according to prior opponent positions. Additionally, the ego-vehicle policy model 316 is configured to update learning parameters of the ego-vehicle policy model using the opponent encoding information from the opponent encoder model to predict actions. The mutual information loss module 318 is configured to update a posterior network according to a mutual information loss between the actions predicted by the ego-vehicle policy model and the opponent encoding information from the opponent encoder model.

As described in further detail below, reinforcement learning is combined with self-supervised learning about one's opponents to find high-performance polices for autonomous racing of the car 350. According to these aspects of the present disclosure, the opponent encoding model 314 outputs opponent information that is helpful for the ego-vehicle policy model 316 to achieve a high reward. These aspects of the present disclosure identify the opponent information that is important for encoding and using by the ego-vehicle policy model 316 and how the ego-vehicle policy model 316 can learn the opponent encoding during a training process performed by the concurrent model training module 312.

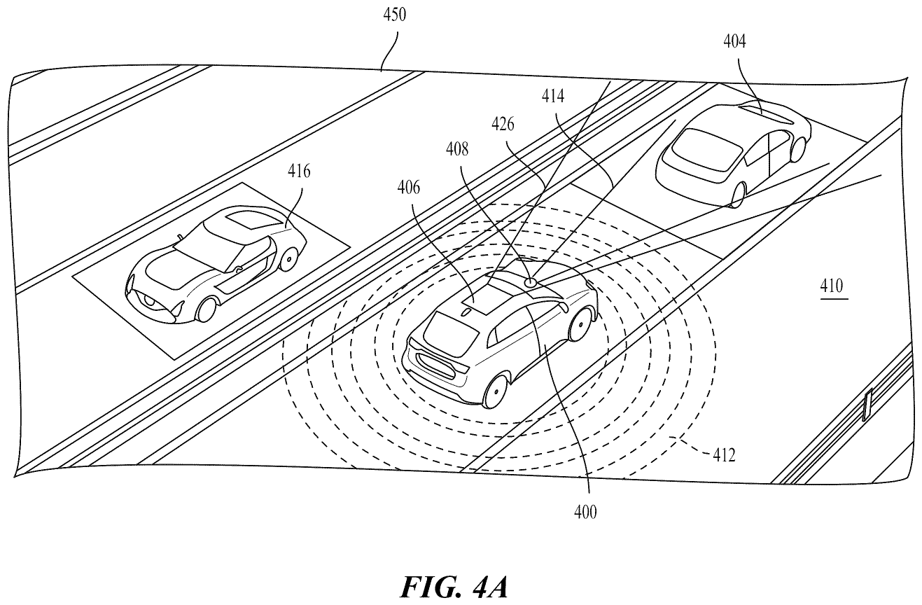

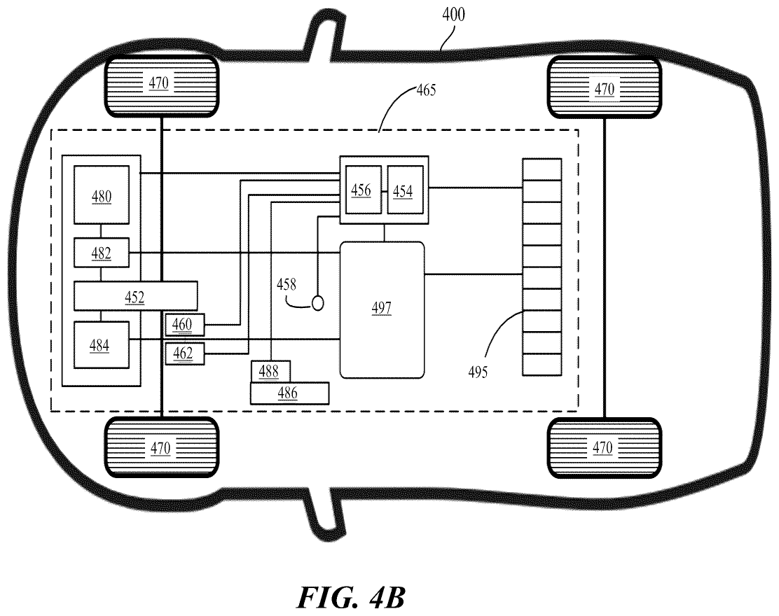

FIGS. 4A-4B are block diagrams illustrating a vehicle configured with a task-aware opponent modeling system, according to aspects of the present disclosure.

FIG. 4A is a diagram illustrating an example of a vehicle 400 in an environment 450, in accordance with various aspects of the present disclosure. In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system (e.g., the sensor module 302). Other sensors, such as radar and/or ultrasound, are also contemplated. Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera's 408 field of view 414. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward-facing field of view, such as the 2D camera's 408 field of view 414 and/or the 2D sensor's 406 field of view 426.

The 2D image captured by the 2D camera 408 includes a 2D image of the first vehicle 404, as the first vehicle 404 is in the 2D camera's 408 field of view 414. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream 424.

The information obtained from the LIDAR sensor 406 and the 2D camera 408 may be used to evaluate a driving environment. In some examples, the information obtained from the LIDAR sensor 406 and the 2D camera 408 may identify whether the vehicle 400 is at an intersection or a crosswalk. Additionally, or alternatively, the information obtained from the LIDAR sensor 406 and the 2D camera 408 may identify whether one or more dynamic objects, such as pedestrians, are near the vehicle 400.

FIG. 4B is a diagram illustrating an example of a vehicle 400, in accordance with various aspects of the present disclosure. Various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and an accelerometer 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. The MGs 482 and 484 can also output torque to the transmission 452. The engine 480 and the MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The accelerometer 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, the engine 480 should provide a fraction of the applied torque to the wheels 470 while one or both MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle 400. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456, to convert direct current (DC) power from the battery 495 to alternating current (AC) power and supply the AC power to the MGs 482 and 484. In some examples, a first MG 482 may be driven by electric power generated by a second MG 484. In embodiments where MGs 482 and 484 are DC motors, no inverter is required. The inverter 497, in conjunction with a converter assembly, may also accept power from one or more of the MGs 482 and 484 (e.g., during engine charging), convert this power from AC back to DC, and use this power to charge the battery 495 (hence the name, motor generator). The ECU 456 may control the inverter 497, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting, during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current because of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both MGs 482 and 484. When the battery 495 is implemented using one or more batteries, the batteries can include, for example, nickel metal hydride batteries, lithium-ion batteries, lead acid batteries, nickel cadmium batteries, lithium-ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

In various aspects of the present disclosure, implementation of the task-aware opponent modeling system 300 of FIG. 3 in the vehicle 400 expands a task-aware opponent modeling policy of the vehicle 400 that is combined with a task-aware opponent encoder to take the opponent's information into consideration by generating actions that can reconstruct the opponent's encoding. This expansion of task-aware opponent modeling improves autonomous racing by utilizing modeled opponent information to improve the performance of the vehicle 400. Despite the high performance achieved by agents trained with reinforcement learning, these agents lack the notion of opponents and do not have a strategic plan on how to best gain advantages over their opponents.

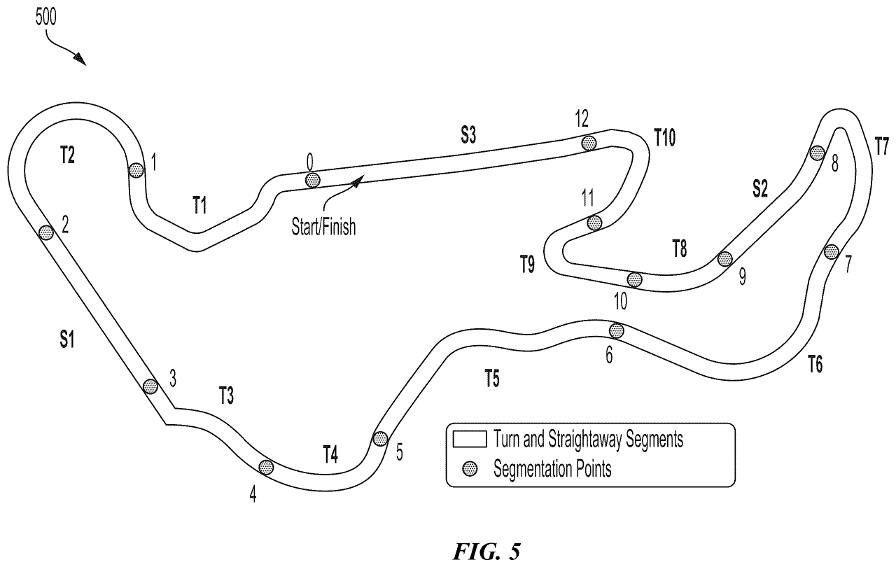

Various aspects of the present disclosure provide a framework that learns to perform a racing task utilizing a simplified reward structure that explicitly models opponent information, which benefits the performance of the vehicle 400 in a multi-agent setting. These aspects of the present disclosure provide a novel contribution to conventional autonomous racing regarding what opponent information should be encoded for a task-aware opponent modeling policy's use and how the vehicle 400 can learn the opponent encoding during the training process, for example, as shown in FIG. 5.

### 1. Preliminaries

Various aspects of the present disclosure use the standard Markov Decision Process (MDP) formalism: [symbol] [symbol] , [symbol] ,T(s′|s, a), R(s, s′), γ, ρ₀(s) [symbol] , where [symbol] is the set of states, [symbol] is the set of actions, T(s′|s, a) is the transition function, R(s, s′) is the reward function, γ is the discount factor, and ρ₀(s) is the initial state distribution. The goal of a reinforcement learning (RL) algorithm is to find a policy, π(a|s), that maximizes the expected return:

$${π}^{*} = arg {max}_{π} {𝔼}_{τ ∼ π} [ {\sum }_{t = 0}^{∞} {γ}^{t} R ( {s}_{t} , {s}_{t + 1} ) ] ,$$

where τ˜π is short for the episode sampling process: S₀˜ρ₀, aₜ˜π(sₜ), sₜ₊₁˜T(·|s, a)∀t≥0.

This example formalizes the problem as a two-player Markov game, a multi-agent extension of an MDP: [symbol] =( [symbol] , { [symbol] }^{1,2}, T, {R}^{1,2}, γ, ρ₀). The Markov game allows each agent to choose its action based on the state, and the transition happens when both agents choose their actions: T(s′|s, a¹, a²). Each agent i then obtains a reward according to its reward function, Rⁱ(s, s′). The superscript −i is used to denote the agent other than the agent i. Each policy's objective is then to maximize its own expected return:

$${π}^{i *} = arg {max}_{{π}^{i}} {𝔼}_{{π}^{i} , {π}^{- i}} [ {\sum }_{t = 0}^{∞} {γ}^{t} {R}^{i} ( {s}_{t} , {s}_{t + 1} ) ] .$$

The objective involves the opponent, π⁻ⁱ, and the proposed approach aims to model and extract helpful information from the opponent's behavior to increase the ego agent's performance.

### 2. Environment

FIG. 5 is a diagram illustrating a multi-agent autonomous racing environment 500, according to various aspects of the present disclosure. FIG. 5 provides an illustration of a racetrack that provides the multi-agent autonomous racing environment 500. The racetrack of the multi-agent autonomous racing environment 500 includes turn segments (e.g., T1, T2, . . . , T10) and straightaway segments (e.g., S1, S2, and S3). Additionally, segmentation points (e.g., 1, 2, . . . , 12) are shown between a start/finish line. In various aspects of the present disclosure, vehicles' dynamics implement an approximation to race car physics, with values for car engine output and tire friction profiles corresponding to realistic ranges. Additionally, a physics profile is tuned using input from professional drivers familiar with the physical course that was virtualized in the simulation and actual vehicles used for the racing task. Some aspects of the present disclosure focus on a two-agent autonomous racing case.

For example, observations given to the agents consist of a 148-dimensional vector, which includes agent-specific observations (distance traveled, its Cartesian coordinates, velocity, acceleration, tire slip angles, yaw rate, heading, and previous action), track information (heading relative to track direction, proportional distance from track center line to track edges, and 30 forward-looking left/right track edge point pairs spaced proportionally to velocity), and the Cartesian coordinates of the other agent. The action space for each agent is a 2-dimensional vector, consisting of the steering angle and combined throttle-brake (normalized to [−1, 1]).

The reward function for each agent consists of three components:

$$R {=}^{def} {R}_{progress} + {R}_{p a s s i n g} + {R}_{c o l l i s i o n} \qquad ( 1 )$$

The first component is the progress reward, as shown in Equation 2, where [symbol] on-track(108 ) denotes the indicator function to test whether the vehicle is on- or off-track and f_{progress}(108 ) is the mapping from vehicle state to the longitudinal position on the track. In other words, the progress reward measures the longitudinal progress on the track, i.e., more progress along the track results in a higher reward, unless the agent goes off-track.

$${R}_{progress} ( {s}_{t} , {s}_{t + 1} ) {on - track}_{} ( {s}_{t + 1} ) \cdot ( {f}_{progress} ( {s}_{t + 1} ) - {f}_{p r o g r e s s} ( {s}_{t} ) ) \qquad ( 2 )$$

The second reward component is a passing bonus: each agent receives a reward for passing the other agent, and a symmetric penalty for being passed. The third reward component is a collision penalty: each agent is penalized for collision with other vehicles to discourage aggressive, unrealistic passing. Note that the reward structure is much simpler (three components) than previous solutions, which consist of eight components, and various aspects of the present disclosure demonstrate that such a simple reward function is indeed enough for inducing performant racing behaviors.

Various aspects of the present disclosure further introduce two-episode termination conditions: out-of-boundary termination, which terminates the episode when the vehicle drives significantly off the track, and a no-progress termination where the vehicle does not have positive forward-moving speed. The two termination conditions work with the reward function to encourage on-track, standard driving. If none of the termination conditions are triggered during the race, the episode is truncated, for example, at 1600 timesteps.

### 3. Method

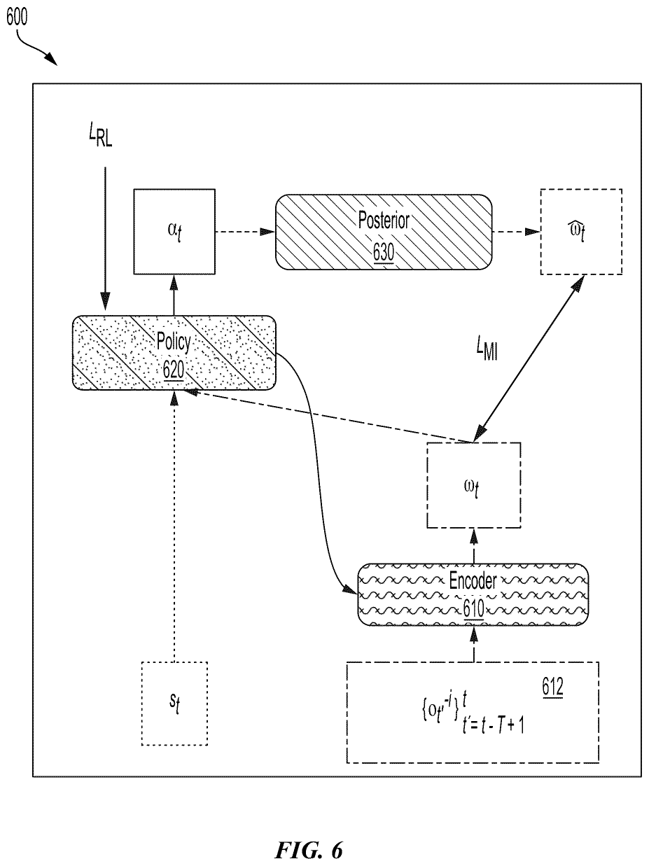

FIG. 6 is a block diagram illustrating a task-aware opponent modeling system 600, according to various aspects of the present disclosure. FIG. 6 illustrates an approach, Learn Thy Enemy (LTE), that overcomes the limitations of previous opponent modeling approaches via a novel mutual-information-maximization objective.

As shown in FIG. 6, the task-aware opponent modeling system 600 includes an opponent-aware encoder 610. A straightforward approach to modeling opponents is to learn to classify different strategies from labeled behaviors. The opponent-aware encoder 610 can be trained by supervised learning signals with the labeled dataset mapping observation history of opponent positions 612,

$${O}_{t} = {\{ {o}_{{t}^{′}}^{- i} \}}_{{t}^{′} = t - T + 1}^{t}$$

(e.g., the opponent's position in the proposed racing task), onto classes or features of an opponent's strategy. The classified strategy information (e.g., opponent information ωₜ) is then fed into an opponent-aware policy 620 as an auxiliary observation to supplement an environment observation, Sₜ.

The task-aware opponent modeling system 600 approach shown in FIG. 6 does not rely heavily on expert knowledge about strategy classes and features that define strategies. More crucially, the opponent-aware encoder 610 is fed with a reinforcement learning objective (e.g., reinforcement learning (L_{RL})), and therefore generates information that the opponent-aware policy 620 utilizes to optimize its performance. This is especially important in settings such as automobile racing where expert knowledge may not be sufficient to define the salient characteristics of good strategies—an expert may be able to identify a policy as high-skill but not necessarily quantitatively characterize what makes it so.

In this example, the opponent-aware encoder 610 is trained with the reinforcement learning (L_{RL}) signal based on a labeled dataset mapping an observation history of the opponent positions 612. In response, the opponent-aware encoder 610 outputs opponent information ωₜ that is utilized by the opponent-aware policy 620 to achieve a high reward. According to various aspects of the present disclosure, the opponent-aware policy 620 is configured to take the opponent information wt into consideration by generating actions aₜ that can reconstruct the opponent's encoding based on the environment observation, sₜ.

In order to implement the opponent-aware encoder 610 and remove the dependency on strong expert knowledge in supervised learning, various aspects of the present disclosure utilize the reinforcement learning signal,

$${L}_{R L} {=}^{def} {𝔼}_{τ ∼ π} [ {\sum }_{t = 0}^{∞} {γ}^{t} R ( {s}_{t} , {s}_{t + 1} ) ] ,$$

to update an encoder model of the opponent-aware encoder 610, assuming a differentiability of a policy model of the opponent-aware policy 620 as shown in FIG. 6.

Although this paradigm allows the opponent-aware encoder 610 to generate helpful encodings for improving the policy's performance, the opponent-aware policy 620 could also largely ignore the output of the encoder, as the output of the encoder during the initial phase of training is random and not useful for learning the task. By the time, the opponent-aware encoder 610 learns to extract helpful information, the opponent-aware policy 620 may already learn to ignore the opponent encoding, ωₜ(since it was not helpful in earlier stages of training).

Accordingly, various aspects of the present disclosure introduce an auxiliary objective that encourages a learned policy output, aₜ, to incorporate the opponent information, ωₜ: the mutual information between aₜ and ωₜ, defined as I(ω; a) [symbol] H(ω)−H(ω|a), where H(⋅) is the entropy. Intuitively, the mutual information can be seen as the decrease in entropy (uncertainty about ω's value) once the action a is known. According to various aspects of the present disclosure, maximizing the mutual information I(ω; a) ensures that given ω, the action a will be less stochastic (e.g., a's choice depends on ω).

Calculating I(a; ω) directly, however, is intractable due to the integral over all possible ω, and therefore various aspects of the present disclosure seek to approximate it with a variational lower-bound, which is denoted as L_{MI} (e.g., the mutual information objective), as shown in Equation (3), where KL denotes the KL-divergence.

$$\begin{matrix}I ( ω ; a ) {=}^{def} H ( ω ) - H ( ω \vert a ) \\ = {𝔼}_{( a , ω ) \sim P ( a , ω )} [ log p ( ω \vert a ) ] + H ( ω ) \\ = {𝔼}_{( a , ω ) \sim P ( a , ω )} [ log \frac{p ( ω \vert a ) q ( ω \vert a )}{q ( ω \vert a )} ] + H ( ω ) \\ = \begin{matrix}{𝔼}_{a \sim P ( a )} [ K L [ p ( ω \vert a ) \vert \vert q ( ω \vert a ) ] ] + \\ {𝔼}_{( a , ω ) \sim P ( a , ω )} [ log q ( ω \vert a ) ] + H ( ω )\end{matrix} \\ \geq {𝔼}_{( a , ω ) \sim P ( a , ω )} [ log q ( ω \vert a ) ] + H ( ω ) \\ {=}^{def} {L}_{MI}\end{matrix} . \qquad ( 3 )$$

The equality of the >holds when q(ω|a) exactly matches the true posterior, p(ω|a).

Contrary to previous mutual information maximization paradigms, the latent information, ω, is not freely sampled but is given by an encoder, g_{ϕ}(Oₜ), dependent on the opponent's behavior history. This has two advantages. First, with a neural network-parameterized ω output distribution, H(ω) is readily calculated to obtain the value of the lower bound instead of ignoring the constant, H(ω). Second, gradients originating from maximizing L_{MI} update not only a posterior network 630 and the opponent-aware policy 620 (the first term of L_{MI}) but also the opponent-aware encoder 610 to extract meaningful, impactful information (both terms of L_{MI}). The task objective, L_{RL}, also updates both the opponent-aware policy 620 and the opponent-aware encoder 610, aiming to find helpful information from opponent behaviors that could contribute to the high performance of the ego agent.

TABLE I
Learn Thy Enemy (LTE)

| Input: | $Training iterations E , opponent policy set {\prod }^{o} = {\{ {π}_{i}^{o} \}}_{i = 1}^{N} where N is the$ |
|---|---|
| | number of opponent policies, learning rate α, number of training iterations for |
| | each environment episode M, opponent history length T, target Q network soft |
| | update coefficient τ. |
| Output: | $Learned ego policy , {π}_{θ} , Q ‐ function , {Q}_{ξ} , target Q ‐ function , {Q}_{Ξ}^{target} , opponent$ |
| | encoder, g_{ϕ} and posterior predictor, q_{ψ}. |
| Initialize: | Initialize neural network parameters θ, ϕ, ψ, ξ. Copy Q parameters ξ to target |
| | Q parameters, Ξ. Empty the replay buffer [symbol] . |

1 for i = 1 to E do

| 2 \| | Collect trajectories {τ} with the current policy, π_{θ}, the current opponent encoder, | |
|---|---|---|
| \| | g_{ϕ} and sampled opponent policy, π^{o} ~ Π^{o} | |
| 3 \| | Add trajectories {τ} to replay buffer β | |
| 4 \| | for j = 1 to M do | |
| 5 \| | \| | Sample minibatch {(sₜ, aₜ, Oₜ, rₜ, sₜ₊₁, Oₜ₊₁)} ~ [symbol] . |
| 6 \| | \| | Calculate opponent encoding ωₜ = g_{ϕ} (Oₜ), ωₜ₊₁ = g_{ϕ} (Oₜ₊₁). |
| 7 \| | \| | Calculate critic loss, |
| \| | \| | L_{critic} huber_loss (Q_{ξ}(sₜ, ωₜ, aₜ), rₜ + Q_{Ξ}^{target} (sₜ₊₁, ωₜ₊₁, π_{θ}(sₜ₊₁, ωₜ₊₁)) and |
| \| | \| | its gradient with respect to ξ. |
| 8 \| | \| | Calculate policy loss, L_{policy} = −Q_{ξ} (sₜ, ωₜ, π_{θ}(sₜ, ωₜ)), and its gradient with |
| \| | \| | respect to θ and ϕ. |
| 9 \| | \| | Calculate mutual information loss, L_{MI} = −log[q_{ψ}(ωₜ\|sₜ, π_{θ}(sₜ, ωₜ)] − |
| \| | \| | H(ωₜ), and its gradient with respect to ψ, θ, and ϕ. |
| 10 \| | └ | Update θ, ϕ, ψ, ξ based on their accumulated gradients with learning rate α. |
| 11 └ | | Soft update the target Q network: Ξ ← (1 − τ)Ξ + τξ. |

Combining the idea of task-aware learning and the mutual information maximization for the opponent-aware encoder 610, a Learn Thy Enemy (LTE) process is shown in Table I. For each training iteration (line 1), first rollouts are collected with the current policy and opponent encoder (line 2) by the generative process:

$${s}_{0} ∼ ρ ( \cdot ) , {ω}_{t} ∼ {g}_{ϕ} ( {O}_{t} ) , {a}_{t}^{1} ∼ {π}_{θ} ( {s}_{t} , {ω}_{t} ) , {a}_{t}^{2} ∼ {π}^{O} ( {s}_{t} ) , {s}_{t + 1} ∼ T ( {s}_{t} , {a}_{t}^{1} , {a}_{t}^{2} ) ∀ t \geq 0 ,$$

where π^{O} denotes an opponent policy. Additionally, trajectories are added into a replay buffer, consistent with an off-policy reinforcement learning approach (line 3).

Next, the training is run for M iterations (lines 4-11). In each iteration, a minibatch is sampled from the replay buffer (line 5), and the opponent encoding information is calculated based on the history of opponent positions (line 6). Next, the three losses, the RL critic loss L_{critic}, the RL policy loss L_{policy}, and the auxiliary mutual information loss L_{MI} are constructed and corresponding gradients are computed in lines 7-9, respectively. In this example, the RL critic loss L_{critic}, is generated based on a Huber loss.

According to various aspects of the present disclosure, the following parameters receive gradient updates from each loss function. For example, the critic loss updates the Q-function parameters, ξ. Both the policy loss and the mutual information loss update the policy parameters, 74 , and the encoder parameters, ϕ, to generate actions that result in high performance in the environment while considering the opponent information and generating helpful opponent information from the encoder. The mutual information loss also updates the posterior network 630, Ψ, to provide correct learning signals for the mutual information loss by lowering the gap between L_{MI} and the true mutual information I(a; ω). Once all gradients are calculated, learning network parameters are updated in line 10, and the target Q network is updated with a soft parameter copy from the Q network in line 11.

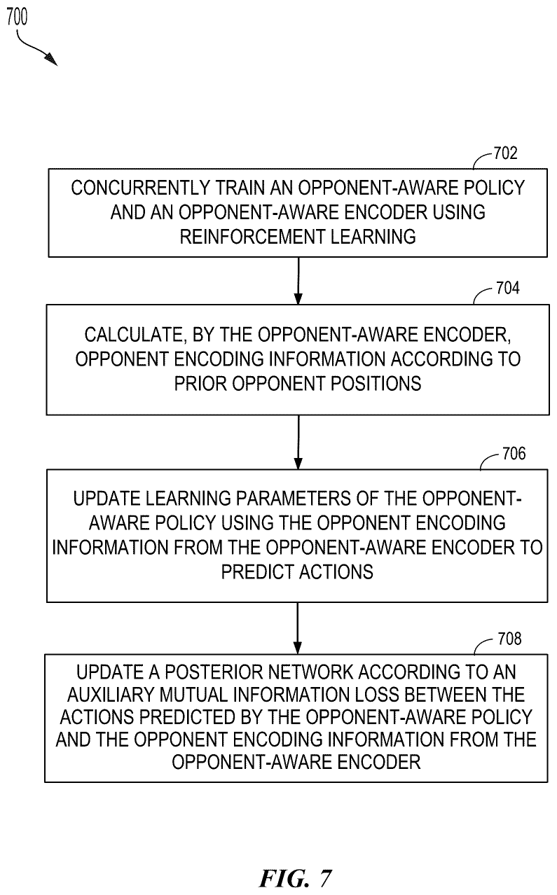

According to various aspects of the present disclosure, an auxiliary mutual information loss L_{MI} updates the posterior network 630 to provide a reconstructed opponent's encoding ωₜ. According to various aspects of the present disclosure, the opponent-aware policy 620 is configured to take the opponent information wt into consideration by generating actions aₜ to provide a reconstructed opponent's encoding ωₜ based on the environment observations, Sₜ. In this example, updating of the posterior network involves determining a reinforcement learning critic loss, a reinforcement learning policy loss, and the auxiliary mutual information loss. A method for task-aware opponent modeling is shown in FIG. 7.

FIG. 7 is a flowchart illustrating a method for task-aware opponent modeling, according to aspects of the present disclosure. A method 700 begins at block 702, in which an opponent-aware policy and an opponent-aware encoder are concurrently trained using reinforcement learning. For example, as shown in FIG. 3, the concurrent model training module 312 is configured to concurrently train an ego-vehicle policy model and an opponent encoder model using reinforcement learning. As shown in FIG. 6, opponent-aware policy 620 and the opponent-aware encoder 610 are concurrently trained using reinforcement learning, such as a reinforcement learning (L_{RL}) signal.

At block 704, opponent encoding information is calculated by the opponent-aware encoder according to prior opponent positions. For example, as shown in FIG. 3, the opponent encoding model 314 is configured to calculate opponent encoding information according to prior opponent positions. As shown in FIG. 6, the opponent-aware encoder 610 is configured to calculate opponent encoding information ωₜ according to prior opponent positions

$${O}_{t} = {\{ {o}_{{t}^{′}}^{- i} \}}_{{t}^{′} = t - T + 1}^{t}$$

(e.g., the opponent's position in the proposed racing task).

At block 706, learning parameters of the opponent-aware policy are updated using the opponent encoding information from the opponent-aware encoder to predict actions. For example, as shown in FIG. 3, the ego-vehicle policy model 316 is configured to update learning parameters of the ego-vehicle policy model using the opponent encoding information from the opponent encoder model to predict actions. As shown in FIG. 6, the opponent-aware policy 620 is configured to take the opponent information ωₜ into consideration by generating actions aₜ that can reconstruct the opponent's encoding based on the environment observation, sₜ to update learning parameters of the opponent-aware policy 620.

At block 708, update a posterior network according to an auxiliary mutual information loss between the actions predicted by the opponent-aware policy and the opponent encoding information from the opponent-aware encoder. For example, as shown in FIG. 3, the mutual information loss module 318 is configured to update a posterior network according to a mutual information loss between the actions predicted by the ego-vehicle policy model and the opponent encoding information from the opponent encoder model. As shown in FIG. 6, the mutual information loss updates the posterior network 630, Ψ, to provide correct learning signals for the mutual information loss by lowering the gap between L_{MI} and the true mutual information I(a; ω).

In some aspects of the present disclosure, the method shown in FIG. 7 may be performed by the SOC 100 (FIG. 1) or the software architecture 200 (FIG. 2) of the vehicle 150. That is, each of the elements or methods may, for example, but without limitation, be performed by the SOC 100, the software architecture 200, the processor (e.g., CPU 102), and/or other components included therein of the vehicle 150, or the task-aware opponent modeling system 300.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of”' a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and nonlinear model predictive control described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for an online, task-aware opponent modeling in autonomous racing, the method comprising:
concurrently training an opponent-aware policy and an opponent-aware encoder using reinforcement learning;
calculating, by the opponent-aware encoder, opponent encoding information according to prior opponent positions;
updating learning parameters of the opponent-aware policy using the opponent encoding information from the opponent-aware encoder to predict actions; and
updating a posterior network according to an auxiliary mutual information loss between the actions predicted by the opponent-aware policy and the opponent encoding information from the opponent-aware encoder.

2. The method of claim 1, in which concurrently training comprises training the opponent-aware encoder using a reinforcement learning signal based on a labeled dataset mapping observation history of opponent positions onto class or features of opponent strategy.

3. The method of claim 1, in which concurrently training comprises training an ego-vehicle policy model using a reinforcement learning signal based on a labeled dataset mapping observation history of opponent positions onto class or features of opponent strategy.

4. The method of claim 1, in which the updating of the learning parameters comprises training the opponent-aware policy to generate the actions that can reconstruct the opponent encoding information based on environment observations.

5. The method of claim 1, in which updating the posterior network comprises determining a reinforcement learning critic loss, a reinforcement learning policy loss, and the auxiliary mutual information loss.

6. The method of claim 5, in which operating the reinforcement learning critic loss is determined according to a Huber loss.

7. The method of claim 1, further comprises performing the autonomous racing using a trained, opponent-aware vehicle policy model and a trained, task-aware opponent encoder.

8. The method of claim 1, further comprising terminating the autonomous racing in response to an out-of-boundary termination when a vehicle drives significantly off a track, and a no-progress termination when a vehicle does not exhibit positive forward-moving.

9. A non-transitory computer-readable medium having program code recorded thereon for an online, task-aware opponent modeling in autonomous racing, the program code being executed by a processor and comprising:
program code to concurrently train an opponent-aware policy and an opponent-aware encoder using reinforcement learning;
program code to calculate, by the opponent-aware encoder, opponent encoding information according to prior opponent positions;
program code to update learning parameters of the opponent-aware policy using the opponent encoding information from the opponent-aware encoder to predict actions; and
program code to update a posterior network according to an auxiliary mutual information loss between the actions predicted by the opponent-aware policy and the opponent encoding information from the opponent-aware encoder.

10. The non-transitory computer-readable medium of claim 9, in which the program code to concurrently train comprises program code to train the opponent-aware encoder using a reinforcement learning signal based on a labeled dataset mapping observation history of opponent positions onto class or features of opponent strategy.

11. The non-transitory computer-readable medium of claim 9, in which the program code to concurrently train comprises program code to train an ego-vehicle policy model using a reinforcement learning signal based on a labeled dataset mapping observation history of opponent positions onto class or features of opponent strategy.

12. The non-transitory computer-readable medium of claim 9, in which the program code to update the learning parameters further comprises program code to train the opponent-aware policy to generate the actions that can reconstruct the opponent encoding information based on environment observations.

13. The non-transitory computer-readable medium of claim 9, in which the program code to update the posterior network further comprises program code to determine a reinforcement learning critic loss, a reinforcement learning policy loss, and the auxiliary mutual information loss.

14. The non-transitory computer-readable medium of claim 13, in which operating the reinforcement learning critic loss is determined according to a Huber loss.

15. The non-transitory computer-readable medium of claim 9, further comprises program code to perform the autonomous racing using a trained, opponent-aware vehicle policy model and a trained, task-aware opponent encoder.

16. The non-transitory computer-readable medium of claim 9, further comprising program code to terminate the autonomous racing in response to an out-of-boundary termination when a vehicle drives significantly off a track, and a no-progress termination when a vehicle does not exhibit positive forward-moving.

17. A system for an online, task-aware opponent modeling in autonomous racing, the system comprising:
a concurrent model training module to concurrently train an opponent-aware policy and an opponent-aware encoder using reinforcement learning;
an opponent encoding model to calculate, by the opponent-aware encoder, opponent encoding information according to prior opponent positions;
an ego-vehicle policy model to update learning parameters of the opponent-aware policy using the opponent encoding information from the opponent-aware encoder to predict actions; and
a mutual information loss module to update a posterior network according to an auxiliary mutual information loss between the actions predicted by the opponent-aware policy and the opponent encoding information from the opponent-aware encoder.

18. The system of claim 17, in which the concurrent model training module is further to train the opponent-aware encoder using a reinforcement learning signal based on a labeled dataset mapping observation history of opponent positions onto class or features of opponent strategy.

19. The system of claim 17, in which the concurrent model training module is further to train the ego-vehicle policy model using a reinforcement learning signal based on a labeled dataset mapping observation history of opponent positions onto class or features of opponent strategy.

20. The system of claim 17, further comprises a vehicle controller to perform the autonomous racing using a trained, opponent-aware vehicle policy model and a trained, task-aware opponent encoder.
